(19) United States
(12) Patent Application Publication
(10) Pub. No.: US 2004/0156414 A1
(43) Pub. Date: Aug. 12, 2004

(54) Excimer or molecular fluorine laser with bandwidth of less than 0.2 pm

(76) Inventor: Sergei V. Govorkov, Boca Raton, FL (US)

Correspondence Address: STALLMAN & POLLOCK LLP, Suite 290, 121 Spear Street, San Francisco, CA, 94105, US

(21) Appl. No.: 10/731,370

(22) Filed: Dec. 9, 2003

Related U.S. Application Data
(60) Provisional application No. 60/439,080, filed on Jan. 8, 2003.

(51) Int. Cl. H01S 3/22

(52) U.S. Cl. 372/55

(57) ABSTRACT

The dispersion plane of a line-narrowed excimer or molecular fluorine laser system can be substantially aligned with the discharge plane, or a plane of approximate current flow between discharge electrodes. Such alignment provides for utilizing a portion of the discharge that is more stable and uniform than in existing systems by avoiding the effects of variations across the current flow on the optical output. A slit aperture can be placed across the discharge direction in order to eliminate the index gradient in the dispersion plane. The beam can be amplified using a separate amplifier chamber, or by having the beam make a second pass through a remaining portion of the gain volume in the laser chamber. To further increase the uniformity of the output beam, the portion of the beam output from the “oscillator” portion can be rotated by 90 degrees before being input to the amplification portion. The amplification pass then can serve as an additional spectral filter, as only spectral components in the center of the beam are effectively amplified.

### CLAIM OF PRIORITY

This patent application claims the benefit of priority to U.S. Provisional Patent Application No. 60/439,080, entitled “EXCIMER OR MOLECULAR FLUORINE LASER WITH BANDWIDTH OF LESS THAN 0.2 PM,” to Sergei V. Govorkov, filed Jan. 8, 2003, which is hereby incorporated herein by reference.

### CROSS-REFERENCE TO RELATED APPLICATIONS

The following U.S. patents and patent applications are hereby incorporated herein by reference:

U.S. patent application Ser. No. 09/23,770 (Publication No. 2002/0021729), entitled “NARROW BANDWIDTH OSCILLATOR-AMPLIFIER SYSTEM,” to Klaus Vogler, filed Feb. 21, 2002; and

U.S. patent application Ser. No. 10/696,979, entitled “MASTER OSCILLATOR-POWER AMPLIFIER EXCIMER LASER SYSTEM” to Gongxue Hua et al., filed Oct. 30, 2003.

### BACKGROUND

Semiconductor manufacturers are presently using relatively short wavelength laser systems, such as excimer and molecular fluorine laser systems, for photolithography applications. These short wavelength lasers are advantageous because the critical dimension, which represents the smallest resolvable feature size that can be produced photolithographically, is proportional to the wavelength used to produce that feature. Such lasers have a relatively high photon energy (i.e., 7.9 eV), which is readily absorbed by high band gap materials such as quartz, synthetic quartz (SiO₂), Teflon (PTFE), and silicone, among others. This absorption leads to excimer and molecular fluorine lasers having even greater potential in a wide variety of materials processing applications. Excimer and molecular fluorine lasers having higher energy, stability, and efficiency are being developed as lithographic exposure tools for producing very small structures as chip manufacturing proceeds into the 0.1 micron regime and beyond. The desire for such submicron features comes with a price, however, as there is a need for improved processing systems capable of consistently and reliably generating such features. For some applications, it is desirable to utilize a narrow band laser. Line-narrowing of a high repetition-rate excimer laser, such as to below 0.2 pm, can be challenging for a number of reasons. For example, acoustic resonances in the chamber can lead to fluctuations in wavelength. There also can be wavelength “chirp” and/or drift in the burst operating mode, as well as instabilities in the discharge that can lead to fluctuations of wavelength and bandwidth.

### FIELD OF THE INVENTION

The present invention relates to the line-narrowing of a high repetition rate laser, particularly an excimer or molecular fluorine laser.

### BRIEF DESCRIPTION OF THE DRAWINGS

FIG. 1 is a diagram of a laser arrangement of the prior art.

FIGS. 2(a) and 2(b) are diagrams of the electrical discharge area between electrodes in a gas discharge laser system.

FIG. 3 is a diagram showing factors defining the output spectrum bandwidth of a line-narrowed laser.

FIG. 4 is a diagram of an oscillator configuration that can be used in accordance with one embodiment of the present invention.

FIG. 5 is a diagram of a laser system that can be used in accordance with embodiments of the present invention.

FIG. 6 is a diagram of another laser system that can be used in accordance with embodiments of the present invention.

FIG. 7 is a diagram of a laser module that can be used with the systems of FIGS. 5 and 6.

FIG. 8 is a diagram of another laser module that can be used with the systems of FIGS. 5 and 6.

FIG. 9 is a diagram showing a beam rotating arrangement of FIG. 5a.

FIG. 10 is a diagram of another laser module that can be used with the systems of FIGS. 5 and 6.

FIG. 11 is a diagram showing a slit orientation that can be used in accordance with various embodiments of the present invention.

FIG. 12 is a diagram of a laser system that can be used in accordance with embodiments of the present invention.

### DETAILED DESCRIPTION

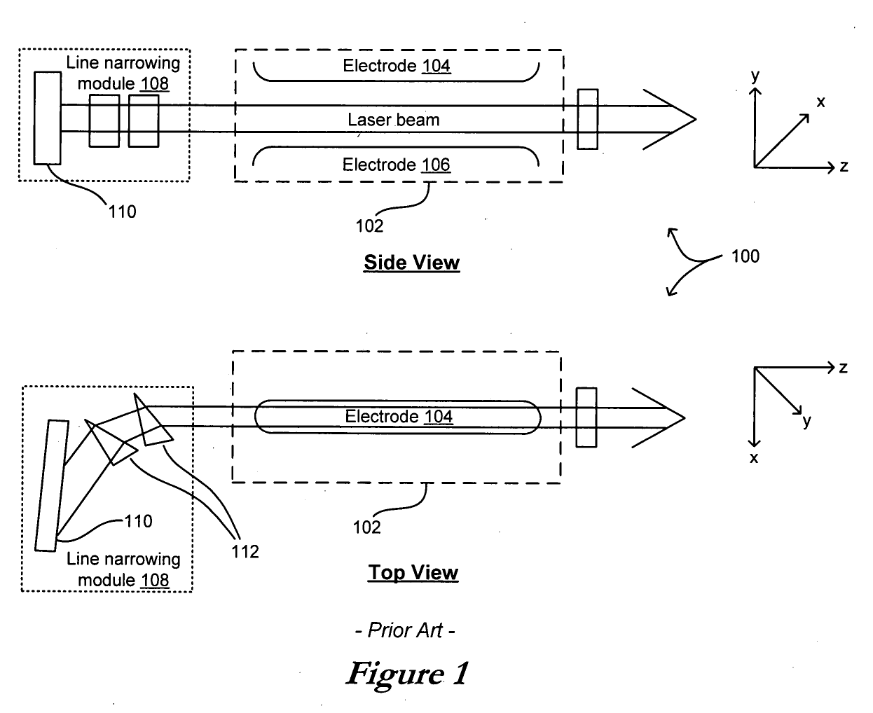

FIG. 1 shows a diagram of an existing arrangement 100 for a line-narrowed excimer laser utilizing wavelength dispersion. In the top view of FIG. 1, the top electrode 104 is shown in the discharge chamber 102. A bottom electrode (not shown) is positioned below the upper electrode, such that the direction of current flow between the electrodes is perpendicular to the y-z plane of the Figure, along the vertical or y-axis. As seen in the side view, the current flows in the y-z plane of the Figure (still along the y-axis) between the upper electrode 104 and lower electrode 106. A line narrowing module 108 is placed in the path of the beam, with a diffraction grating 110 acting as one of the resonator mirrors for the laser system. A beam expander and diffraction grating 110 can be used to select the wavelength of the laser. As is known in the art, a one-dimensional diffraction grating will disperse light in a direction parallel to a dispersion plane for the grating. In such an arrangement, the area between the electrodes can function as a soft aperture by inherently limiting the effective angular spread, such that hard apertures or slits are not necessary for the bandwidths used. Additional line narrowing elements such as prisms 112 also can be placed in the beam path within the line narrowing unit 108. As can be seen in the Figure, the diffraction grating is positioned relative to the electrodes in the discharge chamber such that the dispersive plane (x-z plane) of the diffraction grating is perpendicular to the plane of current flow, or discharge plane (y-z plane), between the electrodes 104, 106.

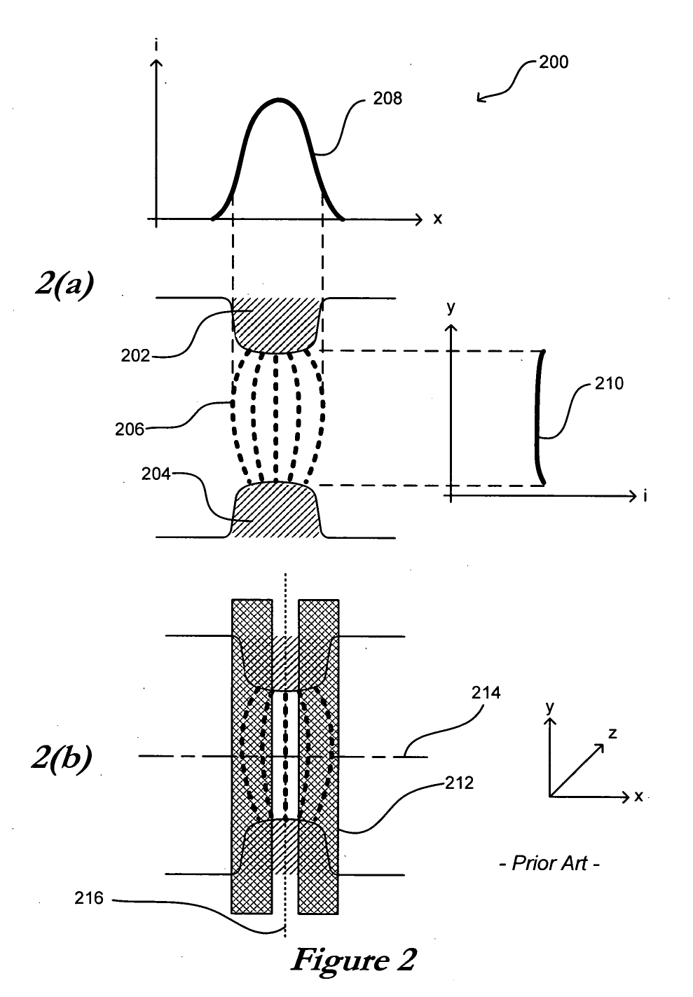

FIG. 2(a) shows a cross-section 200 of charge flow paths 206 between electrodes 202, 204 in a system such as that of FIG. 1. As can be seen from the Figure, the discharge cross-section is elongated in the y-axis direction, with the current density and gain distribution being much narrower in x-direction across the discharge. If parameters of the discharge such as gain and current distribution are monitored along the x-axis, the parameters will show statistical variations from pulse to pulse. The parameters will also change, or drift over time, due to factors such as gas condition, electrode wear, and voltage amplitude. As can be seen in the Figure, the discharge can follow a number of paths, with plot 208 showing an electric current density curve for the location of the discharge over time. If the same parameters are monitored along the y-axis, however, the parameters will be significantly more uniform, as well as more stable, both on a pulse-to-pulse basis and over time. Further, it can be seen that the vertical distribution 210 of charge is significantly more uniform. In many existing systems, the discharge is wide enough that these fluctuations are generally acceptable. As the bandwidth narrows significantly, however, non-uniformities in the discharge become increasingly problematic.

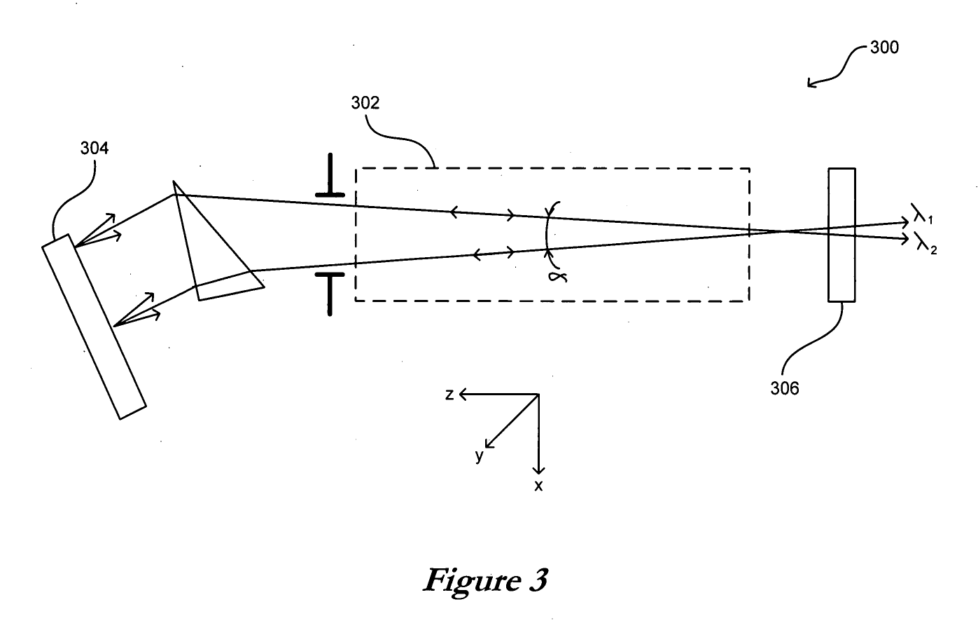

FIG. 3 illustrates schematically a major limitation in the line-narrowing principle used in a prior art laser system 300, such as is shown in FIG. 1. The width of the discharge, as well as the length of the discharge chamber 302 and the inclusion of any slit apertures and chamber length, can define the maximum effective angular spread a of the beam within the chamber 302. Since the wavelength (λ) is defined by the reflection angle of the diffraction grating 304, each ray reflected from the grating will have a unique wavelength at a certain angle. The greater the angular dispersion (dα/dλ), the smaller the wavelength spread corresponding to a particular value of the angular spread, as given by the formula:

Δλ=(dα/dλ)⁻¹Δα

Variations of the gain profile along the x-axis (as shown in FIG. 2(a)) will effectively change the angle of beam propagation in the resonator, and therefore also will change the wavelength. Averaged over several pulses, this can lead to a greater angular spread, and broader bandwidth of the output.

Additionally, there can be variations of the refractive index along the x-axis, caused by factors such as plasma temperature and density variations. Such index variations can lead to a refraction of rays in the gain volume. In turn, any distortion of the beam path within the discharge can lead to increase in the angular spread. Another potential factor is that the gain distribution along x-axis generally varies depending on the y-coordinate. Since the output of the laser is an average over the entire cross section of the discharge, variations of central wavelength along y-axis can lead to broadening of the output beam spectrum.

One method of improving line narrowing that has been commonly utilized in the prior art includes the insertion of a vertical slit aperture 212 in the beam path, such as is shown in FIG. 2(b). Here, the slit is oriented along the y-axis, parallel to the discharge plane 216 (y-z plane) and perpendicular to the dispersion plane 214 (x-z plane). Such use of a vertical slit reduces the allowed range of propagation angles Δα, thereby narrowing the output spectrum of the laser. A negative consequence of such an approach is that only a portion of the discharge area is involved in forming the beam. Since the total current through the discharge is defined by the electric pulse source, or pulser, the amount of discharge current can be highly reproducible from pulse to pulse. When only a small portion of the discharge area is utilized, however, variations of the discharge relative to that small portion can occur from pulse to pulse. Selecting a single portion in this way serves to increase fluctuations in output pulse energy.

Systems and methods in accordance with embodiments of the present invention can overcome these and other deficiencies in existing laser systems by taking advantage of the fact that the gas density, temperature, and other parameters in the discharge are far more stable and uniform in the direction along the current flow, or parallel to the discharge plane, than across the flow, or perpendicular to the discharge plane. The effect of high-frequency acoustic resonances on the wavelength stability is known, such as is discussed in U.S. Pat. No. 6,317,447 B1, which is incorporated herein by reference. Modifications in temperature and pressure of the gas can lead to modification of the refractive index, which can become non-uniform within the discharge cross-section. This can lead to an effective thermal lens or wedge, which can deflect and/or cause a change in the wavelength of the beam.

As the parameters can be more uniform along the current flow, or in the discharge plane between the discharge electrodes along the y-axis, it can be advantageous to align the plane of the wavelength dispersion parallel to the discharge plane, rather than perpendicular to the plane as in a conventional line-narrowed excimer laser. Further, at least one slit aperture can be used that is oriented perpendicular to the dispersion plane. In such an orientation, the index variation will be mainly along the slit and will not lead to a deflection of the beam in the dispersion plane. Deflection of the beam can be caused by the variation of the refractive index along the slit, in the x-direction, which effectively forms a lens and/or a wedge. Since these effects occur in a plane perpendicular to the dispersion plane, however, the wavelength and bandwidth are not affected. Further, the slit can be made quite narrow since the resulting loss of pulse energy can be recovered on an amplification pass. Since the slit is oriented primarily along x-axis, the current density is a highly reproducible value when integrated over the entire slit.

The effect of wavelength “chirp” in a “burst” operating mode has a similar physical origin. Gas parameters, such as temperature, pressure, and refractive index, are modified during the discharge pulse. In high-frequency operation, gas is not completely replaced in the discharge area between the pulses. This can lead to the refractive index gradient being perpendicular to the discharge, as discussed above. There can be a dynamic equilibrium point at a high pulse frequency where the beam is deflected, albeit at a constant angle. In burst mode, however, at least the first pulse can encounter a completely fresh gas in the entire discharge volume. Establishing a stable dynamic equilibrium can take several pulses. Having the slit aperture across the discharge direction can eliminate the index gradient in the dispersion plane, here parallel to the discharge plane, thus eliminating wavelength modulation in the beginning of the burst. The term “discharge plane” is used generally herein to refer to an imaginary plane passing axially between the approximate and/or effective centers of the discharge electrodes, along a direction in which the discharge will generally travel, such as on average or in an ideal situation. The actual discharge pulses between the electrodes can vary about this plane, and can vary in position, such as is shown in FIG. 2. Each discharge generally will not be planar, and can vary in shape from pulse to pulse.

Further, the structure of the discharge (e.g., density of electric current) is known to be dependent on various conditions, such as the age of the gas and the wear on the electrode. These variations affect mostly optical gain and refractive index distributions in the direction perpendicular to the discharge, as the electrodes can flatten over time. When orienting the dispersion plane substantially parallel to the discharge plane, a line-narrowed excimer or molecular fluorine laser can be uniformly and stably operated with a narrow linewidth, such as on the order of less than 0.2 pm. The center wavelength stability can be improved at a high repetition rate (e.g. above 3 kHz) in burst operation mode.

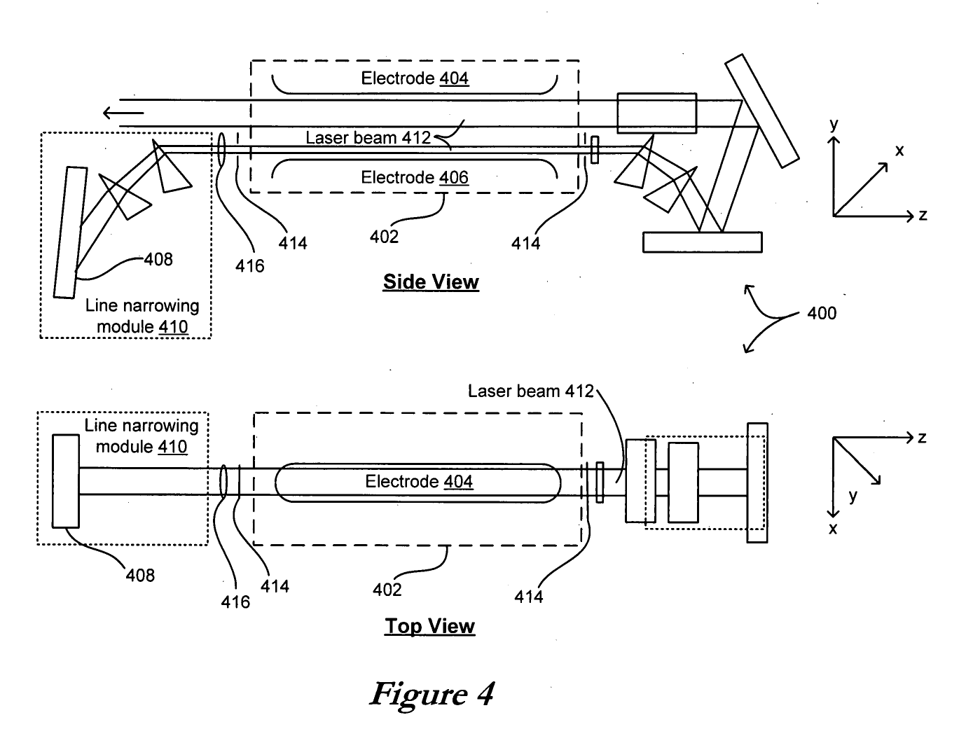

FIG. 4 shows an optical layout 400 for a line-narrowed oscillator in accordance with one embodiment of the present invention. As seen in the side view, a discharge chamber 402 has an upper electrode 404 and a lower electrode 406 that, upon discharge, allow current to flow between the electrodes substantially in the y-z plane, or substantially along the y-axis, parallel to the discharge plane. A diffraction grating 408 of a line-narrowing module 410 can be aligned such that the dispersion plane of the grating 408, and hence the dispersion of the beam 412, also is approximately in the y-z plane, substantially parallel to the plane of the electrical discharge current between the anode and cathode of the discharge chamber. As discussed above, parameters such as the gain, current distribution, and refractive index can be significantly more uniform in the plane of the current flow, instead of across the flow, such that substantially aligning the dispersion plane with the discharge plane can provide for a smaller and more stable angular spread. While having the dispersion plane perpendicular to the discharge plane might represent a least desirable configuration, and having the dispersion plane parallel to the discharge plane might represent a most desirable configuration in at least some configurations, it should be understood that other angle orientations can be used that would obtain at least some of the advantages of embodiments of the present invention, such as being at least slightly more stable and uniform than a perpendicular orientation. In some embodiments, the closer the dispersion plane and discharge plane get to being parallel, the more stable and uniform the results. For instance, there can be an optimal range for certain embodiments, such as within 10 degrees of perpendicular, that can provide for sufficiently stable and uniform results.

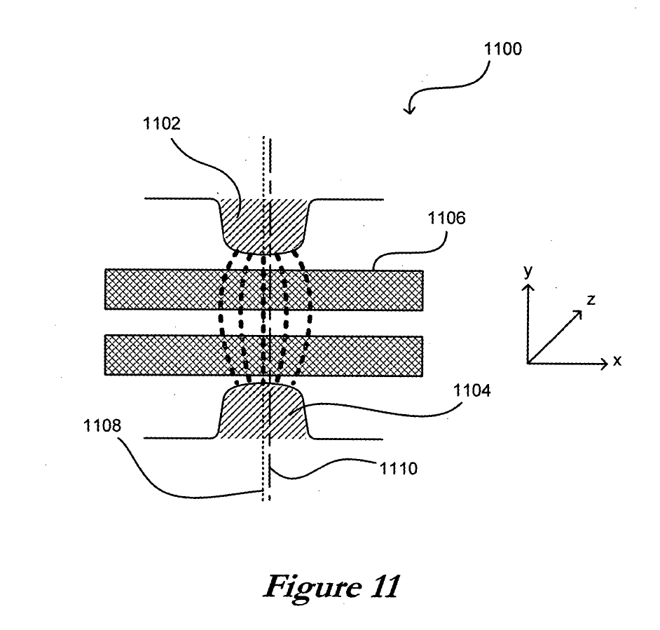

In the layout 400 of FIG. 4, at least one slit aperture 414, or hard aperture, is placed along the beam path between the line-narrowing module 410 and the discharge chamber 402. In some embodiments, a slit aperture is required on each side of the discharge chamber along the beam path. As seen in the orientation 1100 of FIG. 11, each slit aperture 1106 can be oriented with the slit substantially along the x-axis, with the dispersion plane 1110 oriented along the y-axis, in the y-z plane, and parallel to the discharge plane 1108 passing between the electrodes 1102, 1104, which can lead to improvements in bandwidth. For example, pulse-to-pulse variations of the beam angle can be reduced since discharge parameter distribution along the y-axis direction is very uniform. Thus, there are almost no optical wedge or lens effects in the y-z plane. The amount of angular spread also is reduced for the same reason. Since lens and wedge effects are small, there also is little to no angular spread broadening when averaged over the length of the slit along the x-direction.

Such an orientation can utilize only a small portion of the discharge volume, which can result in relatively low output pulse energy. A second pass through the gain volume can be used for purposes of amplification. An exemplary second pass is shown in FIG. 4. Since the output is still less than is obtainable with complete utilization of the gain volume, this concept also can be used with a dual chamber or oscillator-amplifier system.

A cylindrical lens 416 positioned between the discharge chamber 402 and the line-narrowing module 410 can serve to correct the possible wave front curvature error. The laser system also can include either a single discharge chamber 402, or multiple chambers. A single-chamber embodiment as shown in FIG. 4 can be functionally divided into a line-narrowed oscillator utilizing a fraction of the gas discharge volume, and a single- or double-pass amplifier portion that utilizes the remaining portion of the gas discharge.

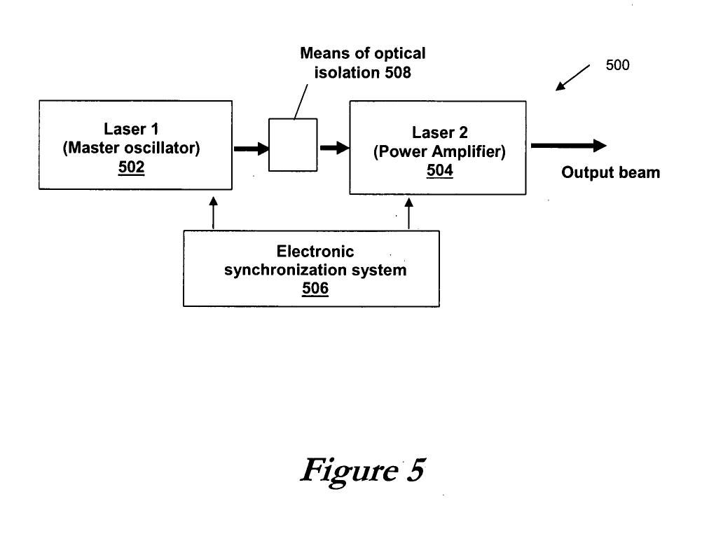

An exemplary layout 500 for an overall laser system is shown in FIG. 5, which includes a first chamber 502, in this case a master oscillator chamber labeled “Laser 1” that is similar to the chamber of FIG. 4. An additional power amplifier chamber 204, labeled “Laser 2,” also is used. Additional amplification stages can be used if necessary, such as by adding additional amplifier chambers to the output of Laser 2. The amplifier can be a single-pass amplifier, a multi-pass amplifier with a retro-reflection or ring beam path, or regenerative ring beam path amplifier. The discharges of the oscillator 502 and amplifier 504 can be controlled through an electronic synchronization system 506, as is known in the art for MOPA (master oscillator/power amplifier) systems. An optical isolation module 508 can be used to decouple the chambers 502, 504. Alternatively, Laser 1 and Laser 2 can be portions of the same discharge chamber, with an isolation module decoupling the passes through the chamber.

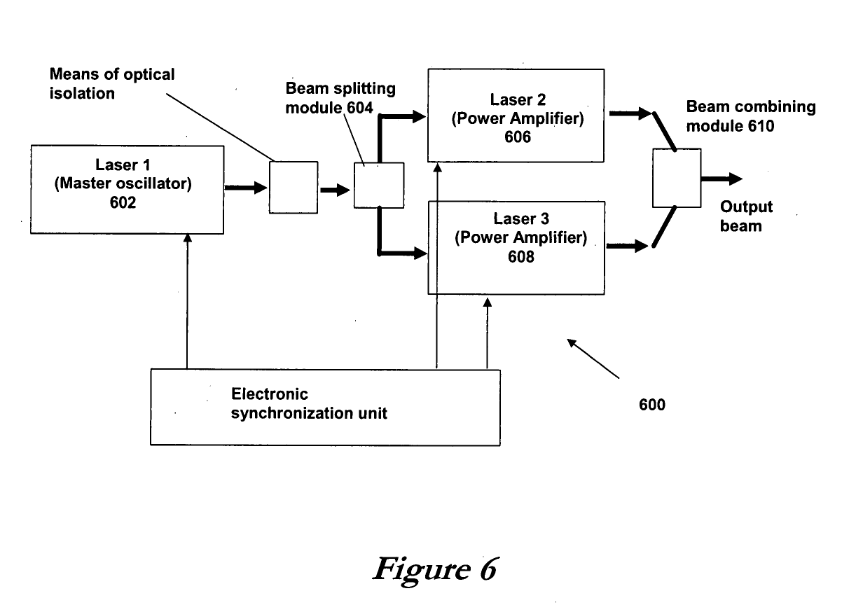

FIG. 6 shows another exemplary system layout 600, wherein the output beam from the master oscillator 602 is split in at least two channels by a beam-splitting module 604. The beam portion for each channel is amplified in a separate amplifier chamber 606, 608. The amplified beams can be combined into a single output beam using a beam combining module 610. An advantage to such an approach is a lower amount of amplified spontaneous emission (ASE), compared to amplifiers that are arranged in series.

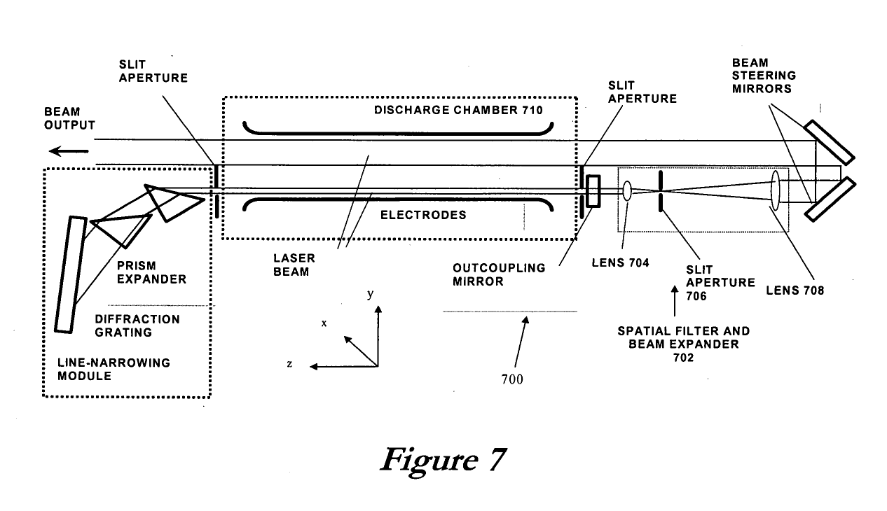

Optical de-coupling can be utilized beneficially between successive stages of amplification in various multi-chamber embodiments, such as those shown in FIGS. 5 and 6. Additionally, such optical de-coupling can be beneficial to use between “oscillator” and “amplifier” portions of a single chamber, such as is shown schematically in FIG. 4. FIG. 7 shows an example of such de-coupling for a laser module 700, which in this example includes a spatial filter 702 with a cylindrical focusing lens 704, a slit aperture 706, and a cylindrical collimating lens 708. In this embodiment, the spatial filter also serves as a beam expander, so as to match the discharge volume on the second and/or subsequent pass (not shown) through this discharge chamber 710.

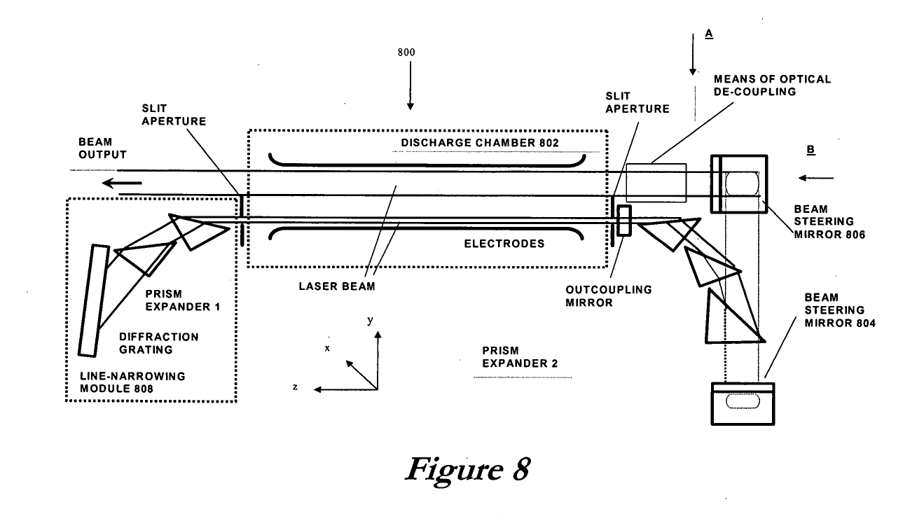

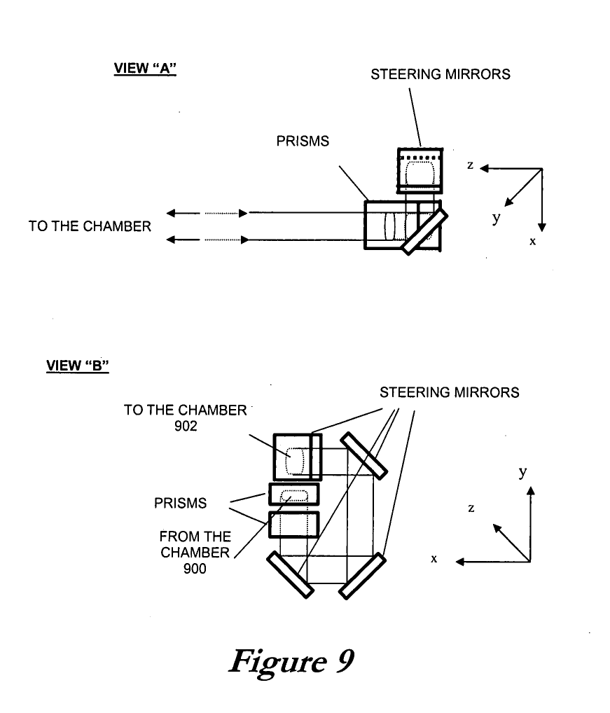

Yet another improvement that can be utilized is shown in the exemplary module 800 of FIG. 8. Here, the output beam of the “oscillator” portion of the discharge chamber 802 is rotated by 90 degrees by beam steering mirrors 804, 806 before being input to the amplification pass. Since the line-narrowing in the oscillator is based on an angular dispersion of the line-narrowing module 808, the output beam of the oscillator can have a wavelength variation across the beam in the plane of dispersion, which again is in the y-z plane of the Figure in this example. After the beam has been rotated, this variation is in the x-z plane, perpendicular to the discharge plane. For example, in FIG. 9 view “B,” the beam 900 from the chamber is shown being elongated in the x-direction in the Figure. After passing through the steering mirrors, the beam 902 that is returned to the chamber for amplification is elongated in the y-direction. The amplification pass (or passes) then can serve as an additional spectral filter, as only spectral components in the center of the beam are effectively amplified. This is due at least in part to the narrow gain distribution along x-axis, as shown in FIG. 2.

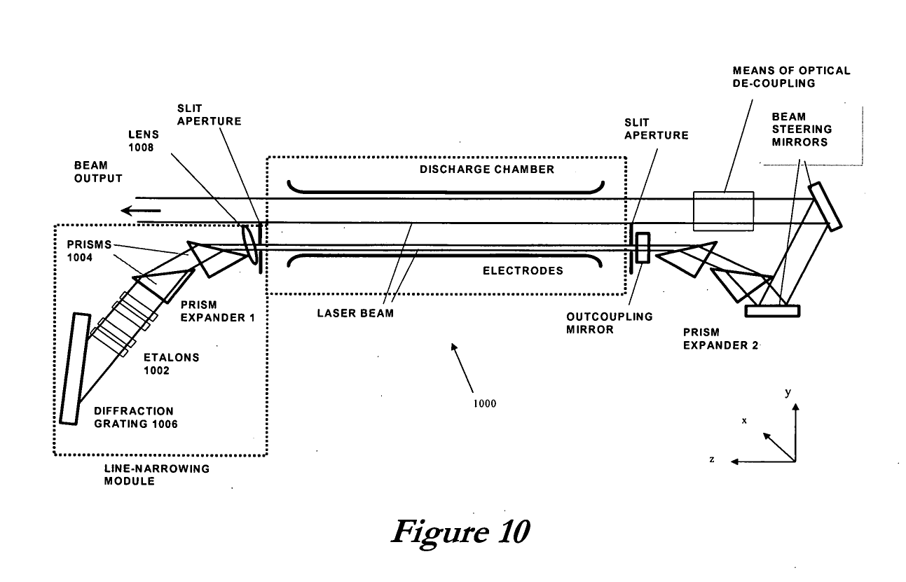

Another exemplary configuration 1000 is shown in FIG. 10, which includes at least one optical etalon 1002 as an additional line-narrowing component. Such an etalon, or a combination of etalons, alternatively can be the primary line-narrowing component. At least one prism 1004 can be used to expand the beam, in order to reduce the divergence of the beam, as well as to reduce the intensity of the beam in the etalon. The diffraction grating 1006 can be replaced in such an embodiment by a highly reflecting mirror. Additionally, a lens 1008 can be used for collimating the beam and further increasing spectral resolution of the line-narrowing components.

Laser System

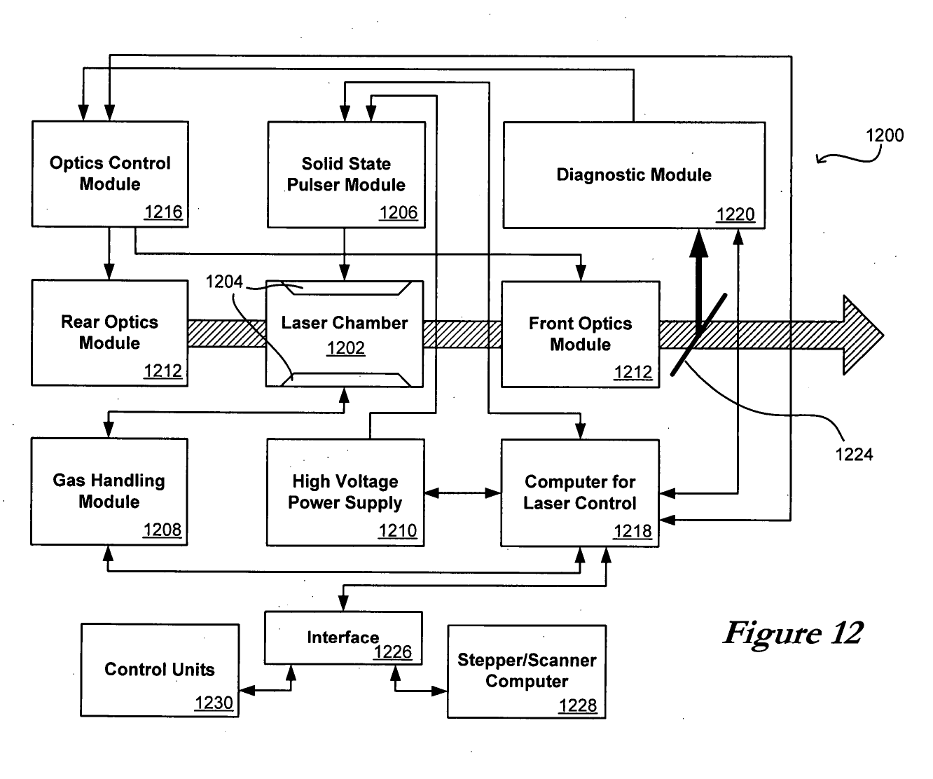

FIG. 12 shows components of an excimer or molecular fluorine laser system 1200 that can be used in accordance with various embodiments of the present invention. The gas discharge laser system can be a deep ultraviolet (DUV) or vacuum ultraviolet (VUV) laser system, such as an excimer laser system, e.g., ArF, XeCl or KrF, or a molecular fluorine (F₂) laser system for use with a DUV or VUV lithography system.

The laser system 1200 includes a laser chamber 1202 or laser tube, which can include a heat exchanger and fan for circulating a gas mixture within the chamber or tube. The chamber can include a plurality of electrodes 1204, such as a pair of main discharge electrodes and one or more preionization electrodes connected with a solid-state pulser module 1206. A gas handling module 1208 can have a valve connection to the laser chamber 1202, such that halogen, rare and buffer gases, and gas additives, can be injected or filled into the laser chamber, such as in premixed forms for ArF, XeCl and KrF excimer lasers, as well as halogen, buffer gases, and any gas additive for an F₂ laser. The gas handling module 1208 can be preferred when the laser system is used for microlithography applications, wherein very high energy stability is desired. A gas handling module can be optional for a laser system such as a high power XeCl laser. A solid-state pulser module 1206 can be used that is powered by a high voltage power supply 1210. Alternatively, a thyratron pulser module can be used. The laser chamber 1202 can be surrounded by optics modules 1212, 1214, forming a resonator. The optics modules 1212, 1214 can include a highly reflective resonator reflector in the rear optics module 1212, and a partially reflecting output coupling mirror in the front optics module 1214. This optics configuration can be preferred for a high power XeCl laser. The optics modules 1212, 1214 can be controlled by an optics control module 1216, or can be directly controlled by a computer or processor 1218, particularly when line-narrowing optics are included in one or both of the optics modules. Line-narrowing optics can be preferred for systems such as KrF, ArF or F₂ laser systems used for optical lithography.

The processor 1218 for laser control can receive various inputs and control various operating parameters of the system. A diagnostic module 1220 can receive and measure one or more parameters of a split off portion of the main beam 1222 via optics for deflecting a small portion of the beam toward the module 1220. These parameters can include pulse energy, average energy and/or power, and wavelength. The optics for deflecting a small portion of the beam can include a beam splitter module 1224. The beam 1222 can be laser output to an imaging system (not shown) and ultimately to a workpiece (also not shown), such as for lithographic applications, and can be output directly to an application process. Laser control computer 1218 can communicate through an interface 1226 with a stepper/scanner computer, other control units 1228, 1230, and/or other, external systems.

The laser chamber 1202 can contain a laser gas mixture, and can include one or more preionization electrodes in addition to the pair of main discharge electrodes. The main electrodes can be similar to those described at U.S. Pat. No. 6,466,599 B1 (incorporated herein by reference above) for photolithographic applications, which can be configured for a XeCl laser when a narrow discharge width is not preferred.

The solid-state or thyratron pulser module 1206 and high voltage power supply 1210 can supply electrical energy in compressed electrical pulses to the preionization and main electrodes within the laser chamber 1202, in order to energize the gas mixture. The rear optics module 1212 can include line-narrowing optics for a line narrowed excimer or molecular fluorine laser as described above, which can be replaced by a high reflectivity mirror or the like in a laser system wherein either line-narrowing is not desired (XeCl laser for TFT annealing, e.g.), or if line narrowing is performed at the front optics module 1214, or a spectral filter external to the resonator is used, or if the line-narrowing optics are disposed in front of the HR mirror, for narrowing the bandwidth of the output beam.

The laser chamber 1202 can be sealed by windows transparent to the wavelengths of the emitted laser radiation 1222. The windows can be Brewster windows, or can be aligned at an angle, such as on the order of about 5°, to the optical path of the resonating beam. One of the windows can also serve to output couple the beam.

After a portion of the output beam 1222 passes the outcoupler of the front optics module 1214, that output portion can impinge upon a beam splitter module 1224 including optics for deflecting a portion of the beam to the diagnostic module 1220, or otherwise allowing a small portion of the outcoupled beam to reach the diagnostic module 1220, while a main beam portion is allowed to continue as the output beam 1220 of the laser system. The optics can include a beamsplitter or otherwise partially reflecting surface optic, as well as a mirror or beam splitter as a second reflecting optic. More than one beam splitter and/or HR mirror(s), and/or dichroic mirror(s) can be used to direct portions of the beam to components of the diagnostic module 1220. A holographic beam sampler, transmission grating, partially transmissive reflection diffraction grating, grism, prism or other refractive, dispersive and/or transmissive optic or optics can also be used to separate a small beam portion from the main beam 1222 for detection at the diagnostic module 1220, while allowing most of the main beam 1222 to reach an application process directly, via an imaging system or otherwise.

The output beam 1222 can be transmitted at the beam splitter module, while a reflected beam portion is directed at the diagnostic module 1220. Alternatively, the main beam 1222 can be reflected while a small portion is transmitted to a diagnostic module 1220. The portion of the outcoupled beam which continues past the beam splitter module can be the output beam 1222 of the laser, which can propagate toward an industrial or experimental application such as an imaging system and workpiece for photolithographic applications.

For a system such as a molecular fluorine laser system or ArF laser system, an enclosure (not shown) can be used to seal the beam path of the beam 1222 in order to keep the beam path free of photo-absorbing species. Smaller enclosures can seal the beam path between the chamber 1202 and the optics modules 1212 and 1214, as well as between the beam splitter 1224 and the diagnostic module 1220.

The diagnostic module 1220 can include at least one energy detector to measure the total energy of the beam portion that corresponds directly to the energy of the output beam 1222. An optical configuration such as an optical attenuator, plate, coating, or other optic can be formed on or near the detector or beam splitter module 1224, in order to control the intensity, spectral distribution, and/or other parameters of the radiation impinging upon the detector.

A wavelength and/or bandwidth detection component can be used with the diagnostic module 1220, the component including for example such as a monitor etalon or grating spectrometer. Other components of the diagnostic module can include a pulse shape detector or ASE detector, such as for gas control and/or output beam energy stabilization, or to monitor the amount of amplified spontaneous emission (ASE) within the beam, in order to ensure that the ASE remains below a predetermined level. There can also be a beam alignment monitor and/or beam profile monitor.

The processor or control computer 1218 can receive and process values for the pulse shape, energy, ASE, energy stability, energy overshoot for burst mode operation, wavelength, and spectral purity and/or bandwidth, as well as other input or output parameters of the laser system and output beam. The processor 1218 also can control the line narrowing module to tune the wavelength and/or bandwidth or spectral purity, and can control the power supply 1210 and pulser module 1206 to control the moving average pulse power or energy, such that the energy dose at points on the workpiece can be stabilized around a desired value. In addition, the computer 1218 can control the gas handling module 1208, which can include gas supply valves connected to various gas sources. Further functions of the processor 1218 can include providing overshoot control, stabilizing the energy, and/or monitoring energy input to the discharge.

The processor 1218 can communicate with the solid-state or thyratron pulser module 1206 and HV power supply 1210, separately or in combination, the gas handling module 1208, the optics modules 1212 and/or 1214, the diagnostic module 1220, and an interface 1226. The processor 1218 also can control an auxiliary volume, which can be connected to a vacuum pump (not shown) for releasing gases from the laser tube 1202 and for reducing a total pressure in the tube. The pressure in the tube can also be controlled by controlling the gas flow through the ports to and from the additional volume.

The laser gas mixture initially can be filled into the laser chamber 1202 in a process referred to herein as a “new fill”. In such procedure, the laser tube can be evacuated of laser gases and contaminants, and re-filled with an ideal gas composition of fresh gas. The gas composition for a very stable excimer or molecular fluorine laser can use helium or neon, or a mixture of helium and neon, as buffer gas(es), depending on the laser being used. The concentration of the fluorine in the gas mixture can range from 0.003% to 1.00%, in some embodiments is preferably around 0.1%. An additional gas additive, such as a rare gas or otherwise, can be added for increased energy stability, overshoot control, and/or as an attenuator. Specifically for a F₂-laser, an addition of xenon, krypton, and/or argon can be used. The concentration of xenon or argon in the mixture can range from about 0.0001% to about 0.1%. For an ArF-laser, an addition of xenon or krypton can be used, also having a concentration between about 0.0001% to about 0.1%. For the KrF laser, an addition of xenon or argon may be used also over the same concentration.

Halogen and rare gas injections, including micro-halogen injections of about 1-3 milliliters of halogen gas, mixed with about 20-60 milliliters of buffer gas, or a mixture of the halogen gas, the buffer gas, and a active rare gas, per injection for a total gas volume in the laser tube on the order of about 100 liters, for example. Total pressure adjustments and gas replacement procedures can be performed using the gas handling module, which can include a vacuum pump, a valve network, and one or more gas compartments. The gas handling module can receive gas via gas lines connected to gas containers, tanks, canisters, and/or bottles. A xenon gas supply can be included either internal or external to the laser system.

Total pressure adjustments in the form of releases of gases or reduction of the total pressure within the laser tube also can be performed. Total pressure adjustments can be followed by gas composition adjustments if necessary. Total pressure adjustments can also be performed after gas replenishment actions, and can be performed in combination with smaller adjustments of the driving voltage to the discharge than would be made if no pressure adjustments were performed in combination.

Gas replacement procedures can be performed, and can be referred to as partial, mini-, or macro-gas replacement operations, or partial new fill operations, depending on the amount of gas replaced. The amount of gas replaced can be anywhere from a few milliliters up to about 50 liters or more, but can be less than a new fill. As an example, the gas handling unit connected to the laser tube, either directly or through an additional valve assembly, such as may include a small compartment for regulating the amount of gas injected, can include a gas line for injecting a premix A including 1% F₂:99% Ne, and another gas line for injecting a premix B including 1% Kr:99% Ne, for a KrF laser. For an ArF laser, premix B can have Ar instead of Kr, and for a F₂ laser premix B may not be used. Thus, by injecting premix A and premix B into the tube via the valve assembly, the fluorine and krypton concentrations (for the KrF laser, e.g.) in the laser tube, respectively, can be replenished. A certain amount of gas can be released that corresponds to the amount that was injected. Additional gas lines and/or valves can be used to inject additional gas mixtures. New fills, partial and mini gas replacements, and gas injection procedures, such as enhanced and ordinary micro-halogen injections on the order of between 1 milliliter or less and 3-10 milliliters, and any and all other gas replenishment actions, can be initiated and controlled by the processor, which can control valve assemblies of the gas handling unit and the laser tube based on various input information in a feedback loop.

Exemplary line-narrowing optics contained in the rear optics module can include a beam expander, an optional interferometric device such as an etalon and a diffraction grating, which can produce a relatively high degree of dispersion, for a narrow band laser such as is used with a refractive or catadioptric optical lithography imaging system. As mentioned above, the front optics module can include line-narrowing optics as well.

For a semi-narrow band laser such as is used with an all-reflective imaging system, the grating can be replaced with a highly reflective mirror, and a lower degree of dispersion can be produced by a dispersive prism. A semi-narrow band laser would typically have an output beam linewidth in excess of 1 pm, and can be as high as 100 pm in some laser systems, depending on the characteristic broadband bandwidth of the laser.

The beam expander of the above exemplary line-narrowing optics of the rear optics module can include one or more prisms. The beam expander can include other beam expanding optics, such as a lens assembly or a converging/diverging lens pair. The grating or a highly reflective mirror can be rotatable so that the wavelengths reflected into the acceptance angle of the resonator can be selected or tuned. Alternatively, the grating, or other optic or optics, or the entire line-narrowing module, can be pressure tuned. The grating can be used both for dispersing the beam for achieving narrow bandwidths, as well as for retroreflecting the beam back toward the laser tube. Alternatively, a highly reflective mirror can be positioned after the grating, which can receive a reflection from the grating and reflect the beam back toward the grating in a Littman configuration. The grating can also be a transmission grating. One or more dispersive prisms can also be used, and more than one etalon can be used.

Depending on the type and extent of line-narrowing and/or selection and tuning that is desired, and the particular laser that the line-narrowing optics are to be installed into, there are many alternative optical configurations that can be used.

A front optics module can include an outcoupler for outcoupling the beam, such as a partially reflective resonator reflector. The beam can be otherwise outcoupled by an intra-resonator beam splitter or partially reflecting surface of another optical element, and the optics module could in this case include a highly reflective mirror. The optics control module can control the front and rear optics modules, such as by receiving and interpreting signals from the processor and initiating realignment or reconfiguration procedures.

Various embodiments relate particularly to excimer and molecular fluorine laser systems configured for adjustment of an average pulse energy of an output beam, using gas handling procedures of the gas mixture in the laser tube. The halogen and the rare gas concentrations can be maintained constant during laser operation by gas replenishment actions for replenishing the amount of halogen, rare gas, and buffer gas in the laser tube for KrF and ArF excimer lasers, and halogen and buffer gas for molecular fluorine lasers, such that these gases can be maintained in a same predetermined ratio as are in the laser tube following a new fill procedure. In addition, gas injection actions such as μHIs can be advantageously modified into micro gas replacement procedures, such that the increase in energy of the output laser beam can be compensated by reducing the total pressure. In contrast, or alternatively, conventional laser systems can reduce the input driving voltage so that the energy of the output beam is at the predetermined desired energy. In this way, the driving voltage is maintained within a small range around HVₒₚₜ, while the gas procedure operates to replenish the gases and maintain the average pulse energy or energy dose, such as by controlling an output rate of change of the gas mixture or a rate of gas flow through the laser tube.

Further stabilization by increasing the average pulse energy during laser operation can be advantageously performed by increasing the total pressure of gas mixture in the laser tube up to Pₘₐₓ. Advantageously, the gas procedures set forth herein permit the laser system to operate within a very small range around HVₒₚₜ, while still achieving average pulse energy control and gas replenishment, and increasing the gas mixture lifetime or time between new fills.

A laser system having a discharge chamber or laser tube with a same gas mixture, total gas pressure, constant distance between the electrodes and constant rise time of the charge on laser peaking capacitors of the pulser module, can also have a constant breakdown voltage. The operation of the laser can have an optimal driving voltage HVₒₚₜ, at which the generation of a laser beam has a maximum efficiency and discharge stability.

Variations on embodiments described herein can be substantially as effective. For instance, the energy of the laser beam can be continuously maintained within a tolerance range around the desired energy by adjusting the input driving voltage. The input driving voltage can then be monitored. When the input driving voltage is above or below the optimal driving voltage HVₒₚₜ by a predetermined or calculated amount, a total pressure addition or release, respectively, can be performed to adjust the input driving voltage a desired amount, such as closer to HVₒₚₜ, or otherwise within a tolerance range of the input driving voltage. The total pressure addition or release can be of a predetermined amount of a calculated amount, such as described above. In this case, the desired change in input driving voltage can be determined to correspond to a change in energy, which would then be compensated by the calculated or predetermined amount of gas addition or release, such that similar calculation formulas may be used as described herein.

It should be recognized that a number of variations of the above-identified embodiments will be obvious to one of ordinary skill in the art in view of the foregoing description. Accordingly, the invention is not to be limited by those specific embodiments and methods of the present invention shown and described herein. Rather, the scope of the invention is to be defined by the following claims and their equivalents.

What is claimed is:

1. A line-narrowed gas discharge laser utilizing wavelength dispersion, comprising:
a resonator including therein a first discharge chamber filled with a gas mixture, the first discharge chamber containing a pair of electrodes connected to a discharge circuit and capable of discharging substantially along a discharge plane between the two electrodes, the discharging of the electrodes energizing the gas mixture and generating a laser beam in the resonator, the first discharge chamber further including at least one window for sealing the first discharge chamber and transmitting the laser beam; and
a line narrowing module positioned along the beam path in the resonator, the line narrowing module including a dispersive element for wavelength selection of the laser beam, the dispersive element having a dispersion plane that is substantially parallel to the discharge plane of the pair of electrodes.

2. A line-narrowed gas discharge laser according to claim 1, wherein:
the dispersive element is a diffraction grating.

3. A line-narrowed gas discharge laser according to claim 1, wherein:
the dispersive element further acts as a resonator mirror for the resonator.

4. A line-narrowed gas discharge laser according to claim 1, wherein:
the line narrowing module further includes at least one prism positioned along a path of the laser beam.

5. A line-narrowed gas discharge laser according to claim 1, further comprising:
at least one slit aperture positioned along a path of the beam in the resonator, the slit aperture oriented perpendicular to the discharge plane.

6. A line-narrowed gas discharge laser according to claim 1, further comprising:
beam redirecting optics capable of directing the laser beam to make a subsequent pass through the first discharge chamber in order to amplify the laser beam.

7. A line-narrowed gas discharge laser according to claim 6, further comprising:
an optical isolation module positioned along a path of the beam in order to optically decouple passes through the first discharge chamber.

8. A line-narrowed gas discharge laser according to claim 6, further comprising:
at least one beam steering mirror capable of rotating the laser beam between passes through the first discharge chamber.

9. A line-narrowed gas discharge laser according to claim 1, further comprising:
a second discharge chamber positioned along the path of the laser beam in order to amplify the laser beam.

10. A line-narrowed gas discharge laser according to claim 9, further comprising:
an electronic synchronization system for controlling the timing of discharges in each of the first and second discharge chambers.

11. A line-narrowed gas discharge laser according to claim 9, further comprising:
an optical isolation module positioned along a path of the beam between the first and second discharge chambers in order to optically decouple the first and second discharge chambers.

12. A line-narrowed gas discharge laser according to claim 1, further comprising:
a cylindrical lens positioned along a path of the laser beam between the first discharge chamber and the line-narrowing module, the cylindrical lens serving to correct wave front curvature error of the laser beam.

13. A line-narrowed gas discharge laser according to claim 1, further comprising:
a beam-splitting module positioned along a path of the laser beam to split the laser beam into first and second channels;
first and second amplifier chambers, each of said amplifier chambers positioned to amplify one of said first and second channels; and
a beam combining module for combining the amplified first and second channels into an output beam.

14. A line-narrowed gas discharge laser according to claim 1, further comprising:
at least one optical etalon positioned along a path of the laser beam and acting as a line-narrowing component for the laser beam.

15. A line-narrowed gas discharge laser utilizing wavelength dispersion, comprising:
a resonator including therein a first discharge chamber filled with a gas mixture, the first discharge chamber containing a pair of electrodes connected to a discharge circuit and capable of discharging substantially along a discharge plane between the two electrodes, the discharging of the electrodes energizing the gas mixture and generating a laser beam in the resonator, the first discharge chamber further including at least one window for sealing the first discharge chamber and transmitting the laser beam;
a dispersion grating positioned along a beam path of the laser beam in the resonator for wavelength selection, the dispersive element acting as a resonator mirror and having a dispersion plane that is substantially parallel to the discharge plane of the pair of electrodes; and
at least one slit aperture positioned along the beam path in the resonator, the slit aperture oriented perpendicular to the discharge plane in order to control at least one of the an angular spread and bandwidth of the laser beam.

16. A line-narrowed gas discharge laser according to claim 15, further comprising:
at least one prism positioned along the beam path in the resonator.

17. A line-narrowed gas discharge laser according to claim 15, further comprising:
beam redirecting optics capable of directing the laser beam to make a subsequent pass through the first discharge chamber in order to amplify the laser beam.

18. A line-narrowed gas discharge laser according to claim 17, further comprising:
an optical isolation module positioned along a path of the beam in order to optically decouple passes through the first discharge chamber.

19. A line-narrowed gas discharge laser utilizing wavelength dispersion, comprising:
a resonator including therein a first discharge chamber filled with a gas mixture, the first discharge chamber containing a pair of electrodes connected to a discharge circuit and capable of discharging substantially along a discharge plane between the two electrodes, the discharging of the electrodes energizing the gas mixture and generating a laser beam in the resonator, the first discharge chamber further including at least one window for sealing the first discharge chamber and transmitting the laser beam;
a line narrowing module positioned along the beam path in the resonator, the line narrowing module including a dispersive element for wavelength selection of the laser beam, the dispersive element having a dispersion plane that is substantially parallel to the discharge plane of the pair of electrodes;
a slit aperture positioned along a path of the laser beam between the first discharge chamber and the dispersive element, the slit aperture oriented perpendicular to the discharge plane in order to control at least one of the an angular spread and bandwidth of the laser beam; and
a second discharge chamber in the resonator, the second discharge chamber capable of receiving the laser beam from the first resonator chamber and amplifying the laser beam before transmitting the laser beam as an output beam.

20. A method of generating laser light using a line-narrowed gas discharge laser; comprising:
generating a laser beam in a resonator of a gas discharge laser system, the gas discharge laser system including therein a discharge chamber filled with a gas mixture, the discharge chamber containing a pair of electrodes connected to a discharge circuit and capable of discharging substantially along a discharge plane between the two electrodes, the discharging of the electrodes energizing the gas mixture and generating the laser beam in the resonator; and
selecting the wavelength of the laser beam using a dispersive element positioned along the beam path in the resonator, the dispersive element having a dispersion plane that is substantially parallel to the discharge plane of the pair of electrodes.

21. A method according to claim 20, further comprising:
controlling at least one of the an angular spread and bandwidth of the laser beam using a slit aperture positioned along a path of the laser beam between the discharge chamber and the dispersive element, the slit aperture oriented perpendicular to the discharge plane.

22. A method according to claim 20, further comprising:
amplifying the laser beam by passing the laser beam through an amplifier chamber.

23. A method according to claim 20, further comprising:
amplifying the laser beam by redirecting the laser beam through the discharge chamber.

24. A method according to claim 23, further comprising:
rotating the laser beam using beam steering optics before redirecting the laser beam through the discharge chamber.

25. A method according to claim 23, further comprising:
de-coupling the laser beam using an isolation module before redirecting the laser beam through the discharge chamber.

26. A line-narrowed gas discharge laser utilizing wavelength dispersion, comprising:
a resonator including therein a first discharge chamber filled with a gas mixture, the first discharge chamber containing a pair of electrodes connected to a discharge circuit and capable of discharging substantially along a discharge plane between the two electrodes, the discharging of the electrodes energizing the gas mixture and generating a laser beam in the resonator, the first discharge chamber further including at least one window for sealing the first discharge chamber and transmitting the laser beam; and
a line narrowing module positioned along the beam path in the resonator, the line narrowing module including a dispersive element for wavelength selection of the laser beam, the dispersive element having a dispersion plane that is at a substantially non-perpendicular angle relative to the discharge plane of the pair of electrodes.
